(19) United States
(12) Patent Application Publication
(10) Pub. No.: US 2022/0018672 A1
(43) Pub. Date: Jan. 20, 2022

(54) METHOD FOR OPERATING A VEHICLE, AND VEHICLE

(71) Applicant: Robert Bosch GmbH, Stutgart (DE)

(72) Inventors: Christoph Woll, Gerlingen (DE); Ulrich Kappenstein, Weil Der Stadt (DE)

(21) Appl. No.: 17/374,259

(22) Filed: Jul. 13, 2021

(30) Foreign Application Priority Data
Jul. 20, 2020 (DE) 102020209044.0

(51) Int. Cl. G01C 21/34; B60L 58/13; B60L 58/16; G08G 1/00

(52) U.S. Cl. CPC G01C 21/3469; B60L 58/13; B60L 2260/54; G08G 1/20; B60L 2260/52; B60L 58/16

(57) ABSTRACT

A method for operating a vehicle. In the method: an allocation parameter of the vehicle is determined; the vehicle is allocated to a group of vehicles using the allocation parameter, at least one comparison vehicle that has an at least partially identical travel route is selected from the group of vehicles allocated to the vehicle; the travel route of the vehicle is subdivided into route sections, and at least one comparison vehicle is selected that travels the same route section or has traveled the same route section; the energy requirement of at least one comparison vehicle is determined; and the state of health of the vehicle is determined and a state-of charge trajectory is predicted therefrom with the aid of the energy requirement of the at least one comparison vehicle on the respective route section, a charging strategy for the vehicle being specified with the aid of the state-of-charge trajectory.

### CROSS REFERENCE

The present application claims the benefit under 35 U.S.C. § 119 of German Patent Application No. DE 102020209044.0 filed on Jul. 20, 2020, which is expressly incorporated herein by reference in its entirety.

### FIELD

The present invention relates to a method for operating a vehicle and to a vehicle.

### BACKGROUND INFORMATION

U.S. Patent Application Publication No. US 2014/278038 A1 describes a vehicle range prediction.

China Patent Application CN 106 989 752 A describes a method and a system for route planning for vehicles having limited onboard vehicle energy.

### SUMMARY

In accordance with an example embodiment of the present, a method for operating a vehicle is provided, in which in a first method step an allocation parameter of the vehicle is determined; in a second method step, the vehicle is allocated to a group of vehicles with the aid of the allocation parameter; in a third method step, at least one comparison vehicle that has an at least partially identical travel route is selected from the group of vehicles allocated to the vehicle; in a fourth method step, the travel route of the vehicle is subdivided into route sections and at least one comparison vehicle, in particular the vehicle selected in the third method step that travels or has traveled the same route section as the vehicle, is selected; in a fifth method step, the energy requirement of at least one comparison vehicle is determined; in a sixth method step, the state of health of the vehicle is determined and a state-of-charge trajectory is predicted therefrom with the aid of the energy requirement of the at least one comparison vehicle on the respective route section, and a charging strategy for the vehicle is specified with the aid of the state-of-charge trajectory.

In accordance with an example embodiment of the present invention, the charging strategy of the vehicle is able to be specified based on the actual energy requirement of the comparison vehicle. The allocation parameter of the comparison vehicle essentially corresponds to the comparison parameter of the vehicle, so that a comparable energy requirement of the comparison vehicle can be expected. The charging strategy is able to be determined based on variable vehicle properties such as the vehicle mass and/or based on a current traffic situation.

Additional advantageous embodiments of the present invention are disclosed herein.

According to one advantageous embodiment of the present invention, the mass of the vehicle is determined as an allocation parameter, in particular with the aid of an acceleration sensor. This makes it possible to improve the determination of the range of the electric vehicle. In particular in the case of electrically driven vehicles having a permissible total mass that is greater than the curb weight of the vehicle, e.g., trucks or buses or shuttle buses, the range has a greater dependency on the mass of the vehicle than passenger cars, for example.

According to a further advantageous embodiment of the present invention, the propulsion power or braking power at a defined gradient or a defined acceleration is used as an allocation parameter. This has the advantage that in the case of vehicles having comparable outer dimensions and/or a comparable drive train, the propulsion power or braking power is sufficient for allocating the vehicles to a group of vehicles. An additional calculation of the mass of the respective vehicle can be omitted.

In accordance with an example embodiment of the present invention, it is furthermore advantageous if, in a seventh method step, charging stations available to the vehicle along the travel route and/or scheduled rest times of the driver are ascertained, the rest times in particular being utilized for charging the electrical energy store, and the charging strategy in particular being specified with the aid of the predicted state-of-charge trajectory and the position of the available charging stations and/or the scheduled rest times. This makes it possible to adapt the charging strategy to the position of the available charging stations and/or the scheduled rest times also while traveling.

In an advantageous manner, in the fifth method step, the energy requirement of the respective comparison vehicle is determined from the measured voltage and the measured current of the comparison vehicle over a defined period of time on the respective route section. This makes it possible to determine the energy requirement of the vehicle using already available sensor data.

In accordance with an example embodiment of the present invention, it is furthermore advantageous if in the fourth method step the particular comparison vehicle is selected that travels the same route section at the same time as the vehicle or that has traveled the same route section shortly before the vehicle. The charging strategy is thereby adaptable to the traffic situation along the respective route section.

In the fourth method step, the route sections are advantageously selected in such a way that they have different velocity ranges and/or different traffic situations and/or different road gradients from one another. The road sections are selected so that the energy requirement of the vehicle on the respective route section is essentially constant.

According to one advantageous embodiment of the present invention, if multiple comparison vehicles are selected in the fourth method step, either the energy requirement of the selected comparison vehicles is averaged in the fifth method step or the energy requirement of the particular comparison vehicle is selected whose allocation parameter deviates the least from the allocation parameter of the vehicle. The precision of the predicted state-of-charge trajectory is therefore able to be improved.

According to a further advantageous embodiment of the present invention, in the fifth method step, if no comparison vehicles are selected in the fourth method step, the energy requirement of the particular comparison vehicle is determined, in particular the vehicle that was selected in the third method step on the respective route section, whose allocation parameter is most similar to the allocation parameter of the vehicle, or the energy requirements of comparison vehicles with adjacent allocation parameters are interpolated in order to determine an expected energy requirement of the vehicle. This makes it possible to carry out the present method even when a vehicle density on the respective route section is low.

In accordance with an example embodiment of the present invention, in an advantageous manner, all vehicles of a respective group of vehicles have an allocation parameter that deviates by less than a specific value, in particular by less than twenty percent, in particular by less than ten percent, from a respective group parameter of the group of vehicles. The respective group parameter is selected in such a way that the groups of two adjacent group parameters to do not overlap one another and/or the groups of two adjacent group parameters abut one another.

It is furthermore advantageous if at least one additional allocation parameter is used, in particular a storage capacity of an electrical energy store of the respective vehicle and/or a power of an electric motor of the respective vehicle. The use of multiple allocation parameters makes it possible to further improve the comparability of the energy requirements within the groups of vehicles.

In accordance with an example embodiment of the present invention, in an advantageous manner, the charging strategy is adapted while the vehicle is driving. Changes in the traffic situation are thereby able to be taken into account.

According to one advantageous embodiment of the present invention, the method steps of the present method are partially executed by a vehicle control of the vehicle and partially by a higher-level external control unit. Method steps that require a high processing power or memory capacity, e.g., the second and/or third and/or fourth and/or sixth and/or seventh method steps, are carried out by the higher-level eternal control unit, and method steps that require only data of the respective vehicle such as the first and/or fifth method step are carried out by the respective vehicle control.

According to another advantageous embodiment of the present invention, the method steps of the method are carried out entirely by a higher-level external control unit. All required data are transmitted to the external control unit and processed by the control unit and possibly stored. This offers the advantage that a vehicle control that has a simple design is sufficient because there is no need to provide processing capacity for the evaluation of the data and the determination of the charging strategy.

It is furthermore advantageous if the predicted state-of-charge trajectory along the travel route is visualized to the driver and/or a control center of the vehicle. This allows the driver or the control center to easily comprehend the predicted state-of-charge trajectory, for instance with the aid of a color code.

In accordance with the present invention, the vehicle is designed to be operated with the aid of a method as disclosed herein.

In accordance with the present invention, the charging strategy of the vehicle is able to be specified based on the actual energy requirement of the comparison vehicle. The allocation parameter of the comparison vehicle essentially corresponds to the comparison parameter of the vehicle, so that a comparable energy requirement of the comparison vehicle can be expected.

The charging strategy is able to be determined based on variable vehicle characteristics such as the vehicle mass and/or based on a current traffic situation.

According to one advantageous embodiment of the present invention, the vehicle has a vehicle control, which is connectable in a date-carrying manner to a higher-level external control unit which has a memory for storing the comparison parameters and the energy requirements of the vehicle and the comparison vehicles, the vehicle control in particular being set up to carry out at least individual method steps of the present method.

In an advantageous manner, the vehicle control is connectable to the higher-level external control unit in a contact-free manner.

If useful, the above embodiments and further refinements are able to be combined as desired. Additional possible embodiments, further refinements and implementations of the present invention also encompass combinations of features of the present invention not explicitly mentioned or described in the previous or following text with regard to the exemplary embodiments. More specifically, one skilled in the art will also add individual aspect as improvements or supplementations to the respective basic form of the present invention.

### BRIEF DESCRIPTION OF THE DRAWINGS

In the following section, the present invention is described based on an exemplary embodiment from which further inventive features may result; however, the scope of the present invention is not restricted to these features. The exemplary embodiment is shown in the FIGURE.

### BRIEF DESCRIPTION OF THE DRAWING

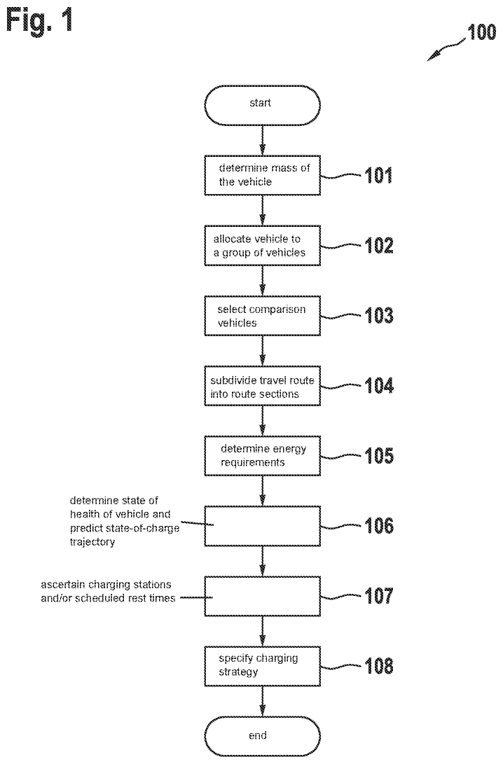

FIG. 1 shows a flowchart of method 100 for operating a vehicle according to the present invention.

### DETAILED DESCRIPTION OF EXAMPLE EMBODIMENTS

FIG. 1 shows a flowchart of method 100 for operating a vehicle according to an example embodiment of the present invention. The described method steps are able to be carried out consecutively in time in the described sequence or also using a different time sequence.

In a first method step 101, the mass of the vehicle is determined as an allocation parameter, in particular with the aid of an acceleration sensor. For this purpose, the propulsion power or braking power is determined when the vehicle accelerates from standstill to a certain velocity or when the vehicle decelerates from a certain velocity to a standstill. Using the propulsion power or braking power and vehicle-specific parameters such as a cross-sectional area and/or a rolling-resistance coefficient, the acceleration resistance of the vehicle is ascertained, and the mass of the vehicle is determined therefrom. Preferably, the mass of the vehicle is displayed to a passenger of the vehicle or to a control center of the vehicle.

The allocation parameter is able to be determined once during the first power take-off after the vehicle has taken on a load and/or passengers, or an average value is formed from multiple power take-off and/or stopping operations.

In vehicles whose vehicle-specific parameters are essentially identical, the mass determination may be omitted and the propulsion power or braking power at a defined gradient or a defined acceleration may instead be used as an allocation parameter in further method 100.

In a second method step 102, the vehicle is allocated to a group of vehicles with the aid of the allocation parameter. All vehicles of a particular group of vehicles have an allocation parameter that deviates by less than twenty percent, in particular by less than 10 percent, from a respective group parameter of the group of vehicles. Multiple further allocation parameters are preferably used such as a memory capacity of the electrical energy store and/or a power of an electric motor of the respective vehicle.

In a third method step 103, comparison vehicles which have an at least partially identical travel route and a fault-free electrical drive train are selected from the group of vehicles allocated to the vehicle. The electrical drive train has at least one electrical energy store and an electric motor.

In a fourth method step 104, the travel route of the vehicle is subdivided into route sections. Then, the particular comparison vehicles are selected from the comparison vehicles selected in third method step 103 that are traveling the same route section at the same time as the vehicle or have traveled the same route section shortly before the vehicle.

The route sections are selected so that they have different velocity ranges and/or a different traffic situation and/or different road gradients from one another.

In a fifth method step 105, the energy requirement of each of the selected comparison vehicles on the same route section is determined, in particular from the measured voltage and the measured current of the electrical energy store of the respective comparison vehicle over a defined time period on the respective route section.

If multiple comparison vehicles were selected in fourth method step 104, then either the energy requirement of the selected comparison vehicles is averaged or the energy requirement of the particular comparison vehicle whose allocation parameters deviate the least from the allocation parameter of the vehicle is selected.

If no comparison vehicles were selected in fourth method step 104, then the energy requirement of the particular comparison vehicle on the particular route section is determined in fifth method step 105 whose allocation parameter is most similar to the allocation parameter of the vehicle. As an alternative, the energy requirements of comparison vehicles with adjacent allocation parameters are interpolated in order to determine an anticipated energy requirement for the vehicle.

In a sixth method step 106, the state of health (SOH) of the vehicle is determined and based on that, a state-of-charge trajectory is predicted with the aid of the energy requirement of the comparison vehicle(s) on the respective route section. Recuperation processes are preferably also taken into account in the process.

In a seventh method step 107, charging stations for the vehicle available along the travel route and/or scheduled rest times of the driver is/are ascertained. The rest times are preferably utilized for charging the electrical energy store.

In an eighth method step 108, a charging strategy is specified using the predicted state-of-charge trajectory and the position of the available charging stations and/or the scheduled rest times.

In the process, the charging strategy is able to be adapted while the vehicle is driving. For instance, a rest time can be advanced or delayed if a charging station is not available as scheduled or when a traffic jam is encountered. Additionally or alternatively, the travel route can be modified in order to circumvent a traffic jam and/or to reach a charge station that is located at a distance from an originally planned travel route.

The method steps of the present method may be carried out partially by a vehicle control and partially by a higher-level external control unit or carried out entirely by a higher-level external control unit. To this end, the higher-level external control unit includes a memory device for storing the comparison parameters and the energy requirements of the vehicle and of the comparison vehicles. The higher-level external control unit is connected in a data-carrying manner to the vehicle control, in particular in a contact-free manner.

The predicted state-of-charge trajectory along the travel route is able to be visualized to the driver and/or a control center of the vehicle. For instance, state-of-charge ranges along the travel route are represented by different colors. A display of a navigation system may be used for this purpose.

In this context, an electrical energy store means a rechargeable energy store, which particularly includes an electrochemical energy storage cell and/or an energy storage module having at least one electrochemical energy storage cell and/or an energy storage pack including at least one energy storage module. The energy storage cell is implementable as a lithium-based battery cell, in particular a lithium-ion battery cell. As an alternative, the energy steerage cell is implemented as a lithium-polymer battery cell or a nickel-metal hydride battery cell, or a lead-acid battery cell or lithium-air battery cell or a lithium-sulfur battery cell.

A vehicle is to be understood as a land vehicle such as a passenger car or a truck or a bus, in particular an at least partially electrically driven vehicle. For instance, the vehicle is a vehicle driven by battery electricity and has a purely electrical drive, or a hybrid vehicle, which has an electric drive and an internal combustion engine.

What is claimed is:

1. A method for operating a vehicle, the method comprising the following steps:
in a first method step, determining an allocation parameter of the vehicle;
in a second method step, allocating the vehicle to a group of vehicles using the allocation parameter;
in a third method step, selecting from the group of vehicles allocated to the vehicle at least one comparison vehicle that has an at least partially identical travel route as a travel route of the vehicle;
in a fourth method step, subdividing the travel route of the vehicle into route sections, and selecting at least one comparison vehicle that travels the same route section or has traveled the same route section as the vehicle;
in a fifth method step, determining an energy requirement of the at least one comparison vehicle;
in a sixth method step, determining a state of health of the vehicle and predicting a state-of-charge trajectory from the determined state of health, using the energy requirement of the at least one comparison vehicle on the respective route section, and specifying a charging strategy for the vehicle using the predicted state-of-charge trajectory.

2. The method as recited in claim 1, wherein the allocation parameter is: a mass of the vehicle determining using an acceleration sensor, and/or a propulsion power or braking power at a defined gradient or a defined acceleration.

3. The method as recited in claim 1, wherein in a seventh method step, charging stations available to the vehicle along the travel route and/or scheduled rest times of the driver, are ascertained, the charging strategy being specified using the predicted state-of-charge trajectory and a position of the available charging stations and/or the scheduled rest times.

4. The method as recited in claim 1, wherein the rest times are used for charging an electrical energy store of the vehicle.

5. The method as recited in claim 1, wherein in the fifth method step, the energy requirement of each respective comparison vehicle is determined from a measured voltage and a measured current of the respective comparison vehicle over a defined period of time on the respective route section.

6. The method as recited in claim 1, wherein only vehicles that have a fault-free electrical drive train are used as comparison vehicles, the electrical drive train having at least one electrical energy store and an electric motor.

7. The method as recited in claim 1, wherein in the fourth method step, the particular comparison vehicle is selected that travels the same route section at the same time as the vehicle or that has traveled the same route section shortly before the vehicle.

8. The method as recited in claim 1, wherein in the fourth method step, the route sections are selected in such a way that they have different velocity ranges and/or different traffic situations and/or different road gradients from one another.

9. The method as recited in claim 1, wherein, in the fifth method step, multiple comparison vehicles are selected in the fourth method step, an energy requirement of the multiple selected comparison vehicles is averaged to form the determined energy requirement.

10. The method as recited in claim 1, wherein, in the fifth method step, an energy requirement of a particular comparison vehicle is selected whose allocation parameters deviates the least from the allocation parameter of the vehicle, as the determined energy requirement.

11. The method as recited in claim 1, wherein in the fifth method step, if no comparison vehicles are selected in the fourth method step, an energy requirement of a particular comparison vehicle on the respective route section is determined whose allocation parameter is most similar to the allocation parameter of the vehicle, or the energy requirements of comparison vehicles with adjacent allocation parameters are interpolated in order to determine an anticipated energy requirement for the vehicle.

12. The method as recited in claim 1, wherein: (i) all vehicles of the group of vehicles have an allocation parameter that deviates by less than a specific value from a respective group parameter of the group of vehicles, and/or (ii) at least one additional allocation parameter is used, the additional allocation parameter including a storage capacity of an electrical energy store of the respective vehicle and/or a power of an electric motor of the respective vehicle.

13. The method as recited in claim 1, wherein the charging strategy is adapted while the vehicle is driving.

14. The method as recited in claim 1, wherein: (i) the method steps are partially carried out by a vehicle control of the vehicle and partially by a higher-level external control unit, or (ii) the method steps are carried out entirely by a higher-level external control unit.

15. The method as recited in claim 1, wherein the predicted state-of-charge trajectory along the travel route is visualized to a driver of the vehicle and/or a control center of the vehicle.

16. A vehicle, comprising:
an electric drive train and an electrical energy store;
wherein the vehicle is configured to be operated with the aid of the following method steps:
in a first method step, determining an allocation parameter of the vehicle;
in a second method step, allocating the vehicle to a group of vehicles using the allocation parameter;
in a third method step, selecting from the group of vehicles allocated to the vehicle at least one comparison vehicle that has an at least partially identical travel route as a travel route of the vehicle;
in a fourth method step, subdividing the travel route of the vehicle into route sections, and selecting at least one comparison vehicle that travels the same route section or has traveled the same route section as the vehicle;
in a fifth method step, determining an energy requirement of the at least one comparison vehicle;
in a sixth method step, determining a state of health of the vehicle and predicting a state-of-charge trajectory from the determined state of health, using the energy requirement of the at least one comparison vehicle on the respective route section, and specifying a charging strategy for the vehicle using the predicted state-of-charge trajectory.

17. The vehicle as recited in claim 16, wherein the vehicle has a vehicle control, which is connectable in a data-carrying manner to a higher-level external control unit, which has a memory configured to store comparison parameters and energy requirements of the vehicle and the comparison vehicles, the vehicle control configured to carry out at least one of the method steps.
